(19) United States
(12) Patent Application Publication
(10) Pub. No.: US 2016/0297574 A1
(43) Pub. Date: Oct. 13, 2016

(54) CLOSURE CAP

(71) Applicant: NESTEC S.A., Vevey (CH)

(72) Inventors: Jean-Paul Cerveny, Vittel (FR); Francois Prevotat, Nancy (FR)

(21) Appl. No.: 15/100,685

(22) PCT Filed: Dec. 1, 2014
(86) PCT No.: PCT/EP2014/076122

§ 371 Date: Jun. 1, 2016

(30) Foreign Application Priority Data
Dec. 2, 2013 (EP) 13195242.6

(51) Int. Cl. B65D 41/04; B29C 45/26

(52) U.S. Cl. CPC B65D 41/0485; B29C 45/2618; B29C 45/2626; B29L 2031/565

(57) ABSTRACT

The present invention concerns a closure cap (10) for capping the aperture (28) of a container (20) having a neck (22) with a male thread (24), the cap (10) comprising a threaded female cylindrical section (16) for engaging the male thread (24) of the neck; said closure cap (10) comprising on its outer surface a skirt (12) comprising outwardly projecting gripping means (13). According to the invention, the gripping means (13) comprise projections (15a, 15b, 7a, 17b) of at least two different kinds.

### FIELD OF THE INVENTION

The present invention relates to a closure cap for a liquid container, to a container comprising said closure cap and to a mold used in the manufacturing of the closure cap.

### BACKGROUND OF THE INVENTION

It is known to equip the neck of a container such as a liquid container, e.g. a bottle, with a closure cap.

It is especially known for plastic bottle to provide a closure cap for capping the mouth of the bottle.

Conventionally, the neck of the plastic bottle is provided with a male thread and the cap for capping the bottle is provided with a corresponding female thread on its inner surface for engaging the male thread around the neck of the bottle.

The threaded sections of both neck and cap are toroidal and may be cylindrical or have a slightly tapered shape. The number and pitch of the threads are largely standardized. Typically the external diameter of the neck (inside diameter of the lid) is about 30 mm. The height of the cap is about 15 mm.

Such caps have a cylindrical outer surface or skirt that has a diameter that is typically 1-2 mm wider than the diameter of the bottle neck. The skirt is often fluted, with knurls perpendicular to the mouth of the cap, for facilitating grip. The top surface of the cap is a circular disk shape that may be slightly domed. Such caps are generally made by injection molding.

Despite the fluting striations, many people, especially the elderly, infirm and children, have difficulty in opening such bottles. This is also especially the case when the cap is short, for example caps having a height around 10 mm. The consumers find difficulty in handling the cap and applying sufficient torque to unscrew the cap from the neck of the bottle.

Furthermore, such caps are also uneasy to handle when consumers need to reclose the bottle.

It should also be noted that small caps increase the risk of choking hazard by children when swallowed.

It has been proposed to make the cap taller but it increases the weight of cap and thereby the cost of it.

The present invention aims at proposing new innovating caps remedying this drawback.

### SUMMARY OF THE INVENTION

In this respect, the invention relates to a closure cap as defined in accordance with claim 1.

The invention thereby proposes to provide the closure cap with gripping means having projections of at least different kinds.

It is to be noted that the cap according to the invention is easier to grip and to handle than prior art closures due to the fact that the cap is wider.

Furthermore, as the gripping means are made of projections projecting outwardly of the skirt of the cap, it allows saving material in comparison to a wider cap without projections.

According to a first feature, the at least two kinds of projections are of distinct shape. The shape is chosen according to the wished effect: rigidity, flexibility, and unscrewing assistance . . . but also on the visual aspect.

According to second feature the at least two kinds of projections are projecting outwardly in different directions. This allows having gripping means projecting in a first direction helping for unscrewing the cap and gripping means projecting in another direction helping for screwing the cap.

According to another feature, the at least two kinds of projections are of different flexibility. Indeed, it could be appreciated to have rigid projections assisting maintaining important torque for the unscrewing and soft projections for a comfortable screwing.

According to a further feature, the at least two kinds of projections are, alone or by group, alternately positioned on the outer surface of the skirt. The proposed alternation gives a nice visual effect but also allows the fingers having the correct projection (for a specific intention) at immediate proximity.

Still according to another feature, the at least two kinds of projections have distinct functions.

In a possible embodiment, the projections have finned shapes. This shape is chosen for allowing efficient grip.

In another possible embodiment, the projections have a U shape which extremities are extending from the skirt. This shape is chosen as allowing applying important torque, especially when the projections are large.

The shape, rigidity, direction and alternation of the projections will determine the level of assistance provided to the consumer for the unscrewing and screwing operations.

The invention also relates to a container comprising:

a neck having an aperture, and

a closure cap mounted on the neck for closing said aperture.

The closure cap equipping said container is according to any of claims 1 to 8.

Thus, if, for instance, the container of the invention is a liquid container, a consumer will easily and in a more convenient manner open and/or close the container of the invention.

This advantage is provided at least by the closure cap of claim 1.

However, the container according to the invention is not limited to a liquid container. For example, the container may alternatively contain other substances as gel, powder, pills, etc.

According to a further aspect, the invention relates to a mold for forming a closure cap of a container by injection molding.

This mold is in accordance with claim 10.

### BRIEF DESCRIPTION OF THE DRAWINGS

The invention is further described with reference to the following examples. It will be appreciated that the invention as claimed is not intended to be limited in any way by these examples.

Embodiments of the present invention will now be described, by way of examples, with reference to the accompanying figures in which:

FIG. 1 is a schematic view of a closure cap according to prior art to be mounted on the neck of a liquid container (partly represented);

FIGS. 2a and 2b are schematic perspective views of a closure cap according to a first embodiment of the invention;

FIG. 3 is a top view of the cap of FIGS. 2a and 2b;

FIG. 4 is a cross-section view on the section plane AA of FIG. 3;

FIGS. 5a and 5b are schematic perspective views of a closure cap according to a second embodiment of the invention;

FIG. 6 is a top view of the cap of FIGS. 5a and 5b;

FIG. 7 is a cross-section view on the section plane AA of FIG. 6;

### DETAILED DESCRIPTION OF THE INVENTION

As used in the following description, the words “comprises”, “comprising”, and similar words, are not to be interpreted in an exclusive or exhaustive sense. In other words, they are intended to mean including, but not limited to.

Any reference to prior art documents in this specification is not to be considered as an admission that such prior art is widely known or forms part of the common general knowledge in the field.

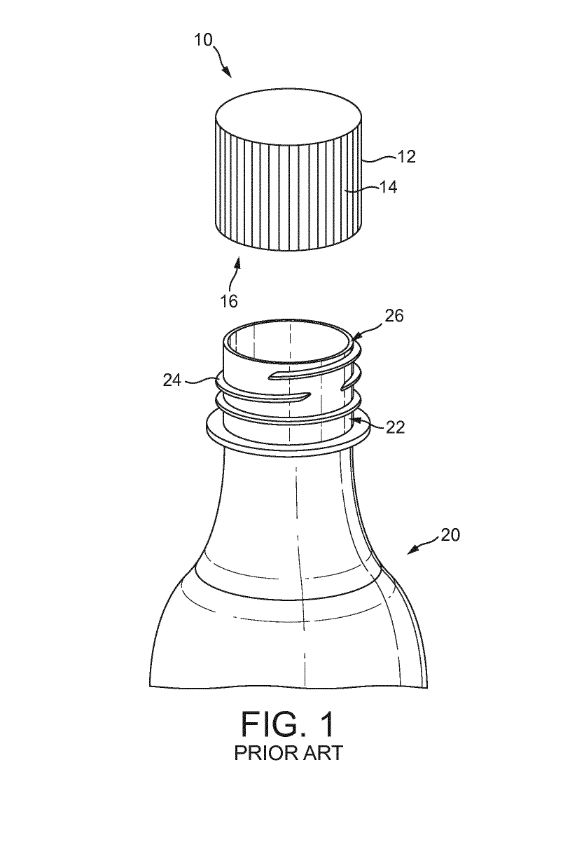

FIG. 1 represents a prior art closure cap 10 for capping the aperture 28 of a plastic container 20 (partial view) in a vertical position.

As already presented in the background of the invention, conventionally the neck 22 of the plastic container 20 is provided with a male thread 24.

The cap 10 comprises a mouth 18 and a cylindrical outer surface called skirt 12. The cap 10 is provided with a female thread 16 on its inner surface, for correspondingly engaging the male thread 24 around the neck 22 of the container 20. The skirt 12 has a diameter shortly wider than the diameter of the container neck 22for engaging around the neck

The threaded sections 24 and 16 of both neck 22 and cap 10 are toroidal.

The skirt 12 comprises knurls 14 perpendicular to the mouth 18 of the cap 10, for facilitating grip.

But in many circumstances, the knurls 14 of skirt 12 are not enough and many people have difficulties in opening and/or closing closure caps.

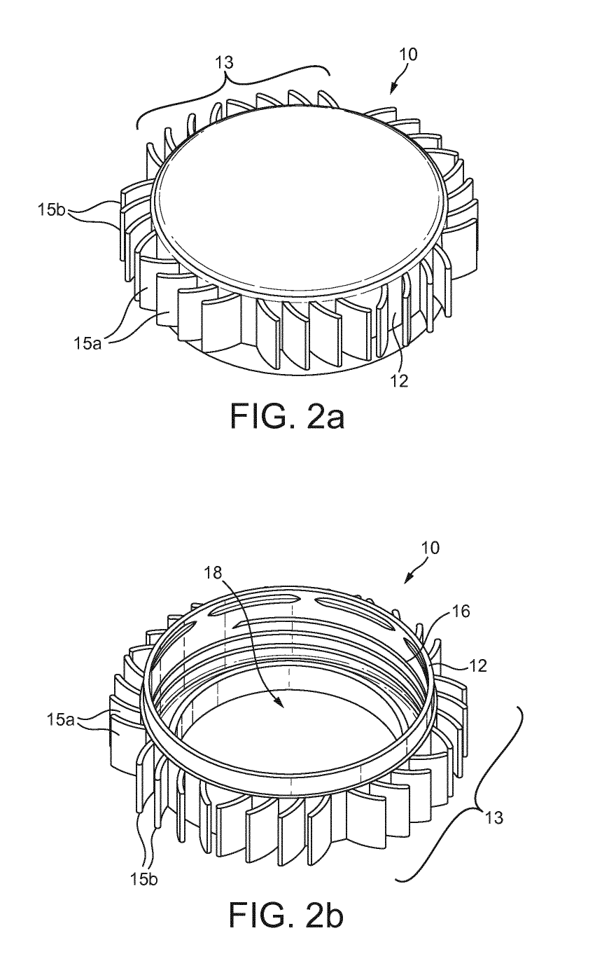

FIGS. 2a, 2b, 3 and 4 show a first embodiment of the invention and will be described together.

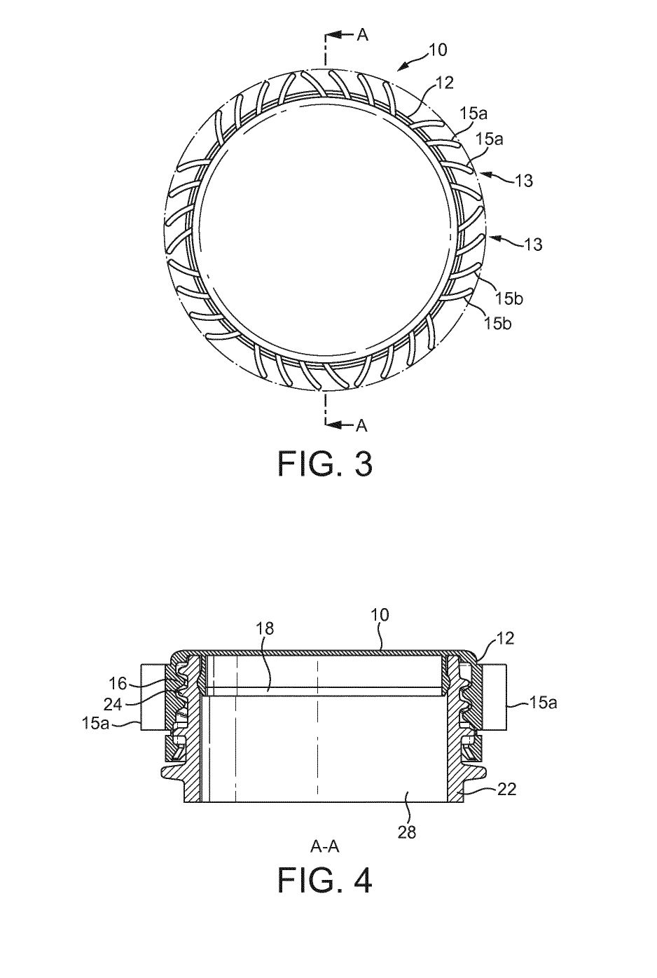

FIGS. 2a and 2b present schematic perspective views of a closure cap and are complementary to FIG. 3 which is a top view of the cap of FIGS. 2a and 2b. In this first embodiment, the closure cap 10 is intended for capping the aperture 28 of a plastic container (only the neck 22 of the container is shown). The characteristic in relation to the threaded sections 24 and 16 on the neck 22 and cap 10 are similar to the prior art.

The cylindrical outer surface of the closure cap 10: skirt 12 comprises extended gripping means 13 projecting vertically and outwardly of the skirt 12. These specific characteristics are shown in FIG. 4 which is a cross-section view on the section plane AA of FIG. 3.

As presented in FIG. 3, said gripping means 13 comprises two different kinds of projections 15a, 15b. Said projections are grouped into two kinds of different projections and said groups alternate on the outer surface of the skirt 12.

In the present case, projections 15a and 15b are grouped by four and alternate around the outer surface of the cap: A group of four projections 15a of a first kind alternates with a group of four projections 15b of the other kind and so on.

Projections 15a and 15b have finned or curvy shapes and as can be clearly seen in FIG. 3, the two kinds of projections are projecting in different directions (clockwise and counterclockwise) around the outer surface of skirt 12.

Due to the projections 15a, 15b, the cap is larger than usual which helps people to handle it.

In addition, as the projections are projecting in different directions, the projections help handling the cap for opening it as well as for closing it on the container. The presented projections allow a real efficient grip and enable to apply important torque without any slide on the cap.

Furthermore, a larger cap may address the choking hazard and therefore makes the cap safer for young children.

However, the invention is not limited to this design of projections as will be explained later on.

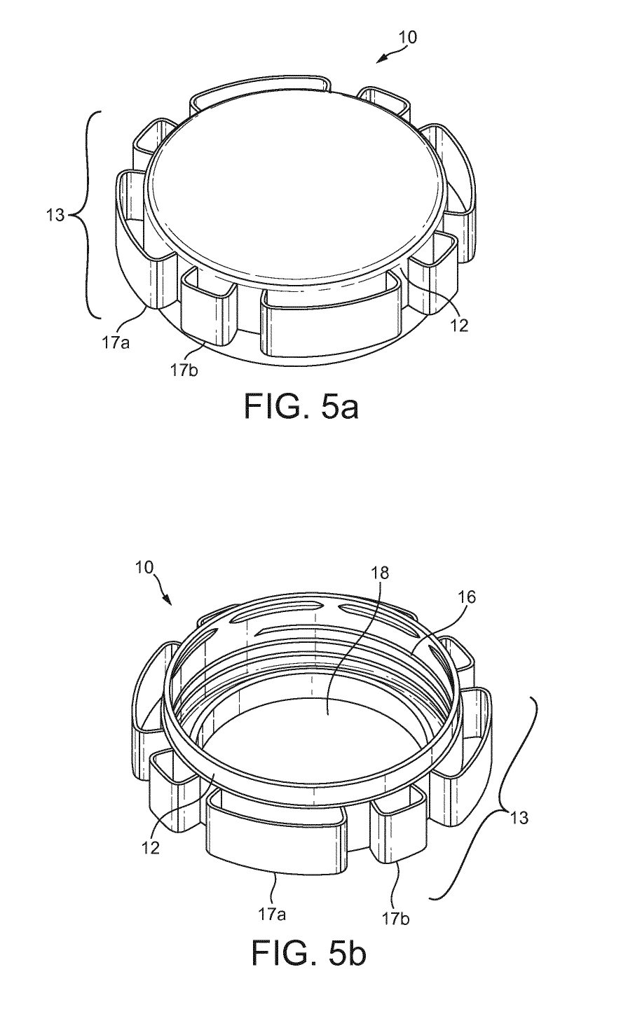

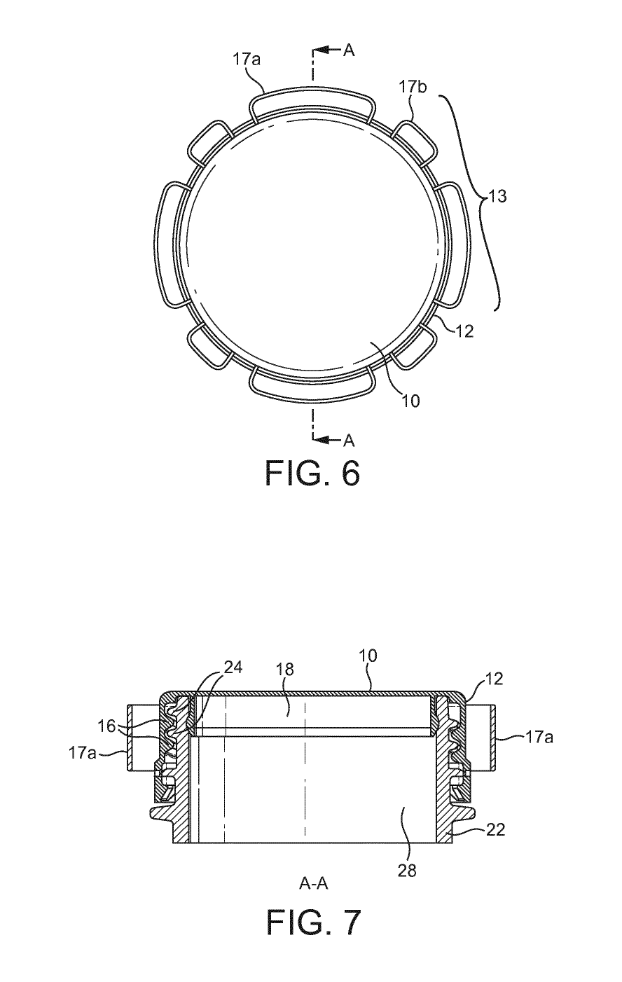

FIGS. 5a, 5b, 6 and 7 show a second embodiment of the invention and will be described together.

In this second embodiment, the references similar to the ones presented in the frame of the prior art and of the first embodiment present elements similar as the ones already described.

In this second embodiment, the projections are different from the ones of the first embodiment.

Both kinds of projections 17a and 17b have a U shape which extremities are extending from the skirt.

In the proposed design, projections 17a have a U base wider than the one of projection 17b. As a consequence, projections 17a are more flexible than projections 17b.

Thanks to the specific shape of projections 17a, the plastic material adapts itself under the force of a user fingers during unscrewing the cap thereby giving softer sensation and better comfort to the consumer.

The specific shape of projections 17a also allows an easier selection of the cap during the capping process.

In the present embodiment there is an alternation of projections 17a and 17b that allows the cap to have a regular design. In addition the four projections 17a give the visual impression of having a square cap more than a round one.

As can be seen from the above, the shape and alternation of the projections can be chosen according to the needed functions in terms of handling and gripping and according to the wished visual effect.

However, the presence of projection allows having wider caps which is very important for an increasing number of people in the most economical way.

It should be understood that various changes and modifications to the presently preferred embodiments described herein will be apparent to those skilled in the art. Such changes and modifications can be made without departing from the scope of the present invention and without diminishing its attendant advantages. It is therefore intended that such changes and modifications be covered by the appended claims.

Furthermore, where known equivalents exist to specific features, such equivalents are incorporated as if specifically referred in this specification.

1. A closure cap for capping the aperture of a container having a neck with a male thread, the cap comprising a threaded female cylindrical section for engaging the male thread of the neck; the closure cap comprising on its outer surface a skirt comprising an outwardly projecting gripper that comprises projections of at least two different kinds.

2. A closure cap according to claim 1 wherein the at least two kinds of projections are of distinct shape.

3. A closure cap according to claim 1 wherein the at least two kinds of projections are projecting outwardly in different directions.

4. A closure cap according to claim 1 wherein the at least two kinds of projections are of different flexibility.

5. A closure cap according to claim 1 wherein the at least two kinds of projections are, alone or by group, alternately positioned on the outer surface of the skirt.

6. A closure cap according to claim 1 wherein the at least two kinds of projections have distinct functions.

7. A closure cap according to claim 1 wherein the projections have a finned shape.

8. A closure cap according to claim 1 wherein the projections have a U shape which extremities are extending from the skirt.

9. A container, comprising:
a neck having an aperture;
a closure cap mounted on the neck for closing the aperture; and
the closure cap comprising a threaded female cylindrical section for engaging a male thread of the neck, the closure cap comprising on its outer surface a skirt comprising an outwardly projecting gripper that comprises projections of at least two different kinds.

10. A mould for forming, by injection molding, a closure cap for capping the aperture of a container having a neck with a male thread, the cap comprising a threaded female cylindrical section for engaging the male thread of the neck, the closure cap comprising on its outer surface a skirt comprising an outwardly projecting gripper that comprises projections of at least two different kinds.
